(19) United States
(12) Patent Application Publication
(10) Pub. No.: US 2011/0169922 A1
(43) Pub. Date: Jul. 14, 2011

(54) THREE DIMENSION MODEL BUILDING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/729,188

(22) Filed: Mar. 22, 2010

(30) Foreign Application Priority Data
Jan. 9, 2010 (CN) 201010300154.4

(51) Int. Cl. H04N 13/02

(52) U.S. Cl. 348/47; 348/E13.074

(57) ABSTRACT

A three dimension model building system includes a number of time-of-flight (TOF) cameras and a processing unit. The number of TOF cameras capture an object to obtain images of the object and distance data between every point on the object and the TOF cameras. The processing unit calculates coordinates of every point on the object in the images from the TOF cameras on an X-axis, an Y-axis, an Z-axis, and obtains a function according to the plurality of coordinates on the X-axis, the Y-axis, and the Z-axis. The processing unit further creates a curved surface according to the function. The curved surface is a three dimension model of the object.

### BACKGROUND

1. Technical Field

The present disclosure relates to a three dimension model building system and a three dimension building method.

2. Description of Related Art

Three dimension (3D) models are used more and more in product design. There are three methods to build a 3D model. The first one is to use 3D model software to build the 3D model. The second is to use a 3D scanner. The third is to use a 2D image to build the 3D model. All the three methods are very precise in meeting various demands.

### BRIEF DESCRIPTION OF THE DRAWINGS

FIG. 1 is a schematic diagram of an exemplary embodiment of a 3D model building system including a storage system and two time-of-flight cameras.

FIG. 2 is a schematic block diagram of the storage system of FIG. 1.

FIG. 3 is a schematic diagram of a ball being captured by the 3D model building system of FIG. 1.

FIG. 4 is an image obtained by one of the two time-of-flight cameras of FIG. 1.

FIG. 5 is a flowchart of an exemplary embodiment of a 3D building method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

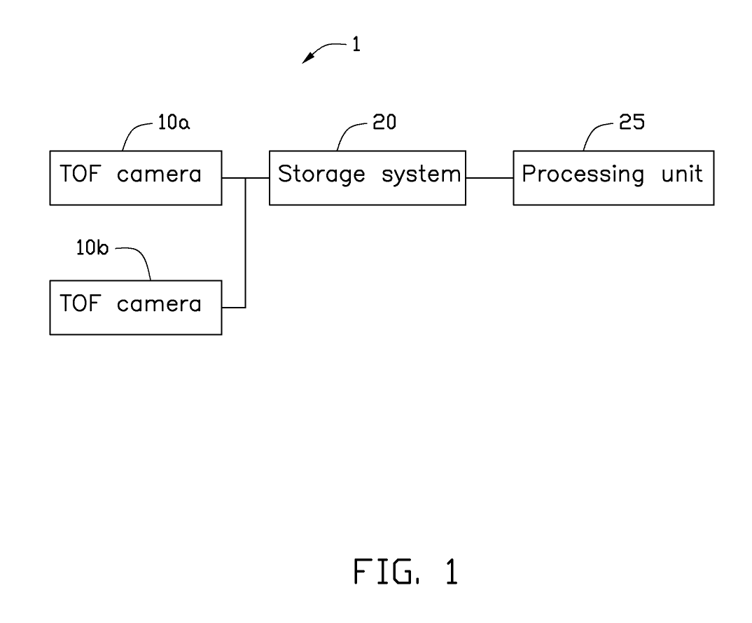

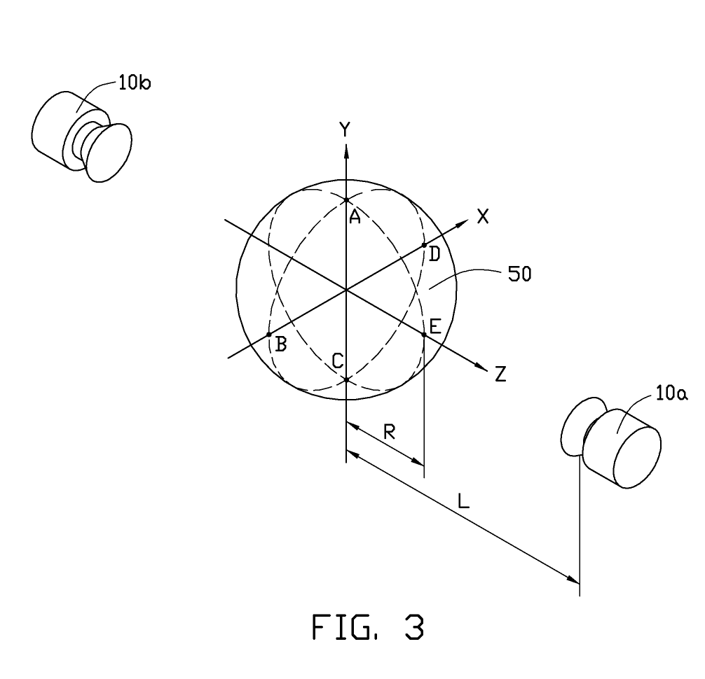

Referring to FIGS. 1 and 3, an exemplary embodiment of a three dimension (3D) model building system 1 is capable of building a 3D model of an object and includes two time-of-flight (TOF) cameras 10a and 10b, a storage system 20, and a processing unit 25.

In the embodiment, the object is a ball 50. The two TOF cameras 10a and 10b shoot the ball 50 from two different views to obtain images of the ball 50. A plurality of points A, B, C, D, and E on the ball 50 are selected. In addition, each of the two TOF cameras 10a and 10b is a camera system that captures two images and obtains distance data between each point A, B, C, D and E on the ball 50 and the corresponding TOF camera 10a or 10b. In the embodiment, the TOF camera 10a or 10b sends electrical signals to the ball 50 and the ball 50 reflects the electrical signals to the TOF camera 10a or 10b in transmit times. As a result, distance data can be obtained according to differences between (the TOF camera 10a or 10b sending the electrical signals and receiving the electrical signals) transmit times. In other embodiments, a plurality of TOF cameras may form a camera array. The camera array is arranged around the ball, to shoot the ball 50 from different views to obtain a plurality of images.

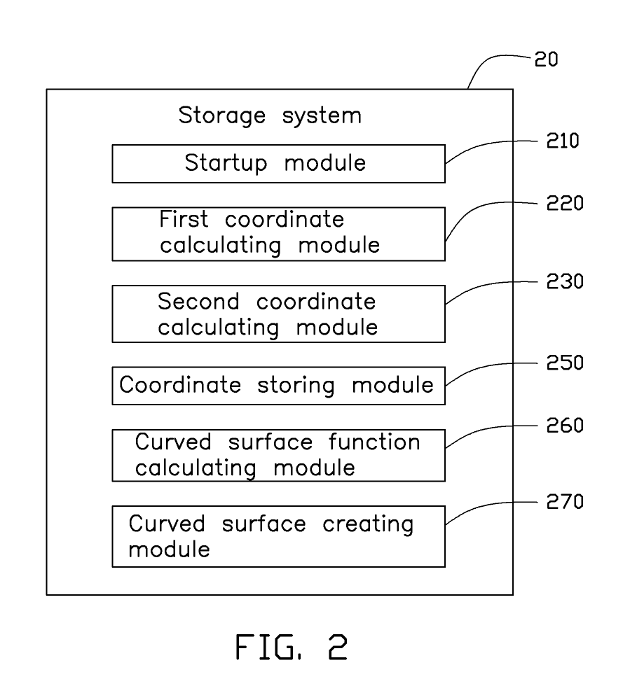

Referring to FIG. 2, the storage system 20 includes a startup module 210, a first coordinate calculating module 220, a second coordinate calculating module 230, a coordinate storing module 250, a curved surface function calculating module 260, and a curved surface creating module 270. The startup module 210, the first coordinate calculating module 220, the second coordinate calculating module 230, the curved surface function calculating module 260, and the curved surface creating module 270 may include a plurality of computerized instructions and are executed by the processing unit 25.

Referring to FIG. 3, the startup module 210 turns on the TOF cameras 10a and 10b. The TOF cameras 10a and 10b shoot the ball 50 from different angles to obtain two images of the ball 50. In addition, the TOF cameras 10a and 10b send electrical signals to the ball 50. The electrical signals would return to the TOF camera 10a and 10b respectively when the electrical signals meet the ball 50. As a result, the distance data between every point on the ball 50 and the TOF camera 10a can be obtained according to the time differences between sending and receiving the electrical signals of the TOF camera 10a. In the same way, the distance data between every point on the ball 50 and the TOF camera 10b can be obtained according to time differences between sending and receiving the electrical signals of the TOF camera 10b.

The first coordinate calculating module 220 calculates coordinates of each point A, B, C, D and E of the ball 50 in the images received from the TOF cameras 10a and 10b on an X-axis and an Y-axis. In the embodiment, a center of each image of the ball 50 is regarded as an origin of the X-axis and the Y-axis.

The second coordinate calculating module 230 calculates coordinates of every point of the ball 50 in the images received from the TOF cameras 10a and 10b on an Z-axis according to the distance data between each point A, B, C, D and E on the ball 50 and the TOF cameras 10a and 10b.

The coordinate storing module 250 stores the coordinates of the points A, B, C, D and E of the ball 50 in the images on the X-axis, the Y-axis, and the Z-axis. As a result, a plurality of groups of coordinates (x, y, z) can be obtained.

The curved surface function calculating module 260 obtains a function according to the plurality of groups of coordinates (x, y, z). It is known that if every point on a curved surface S accords with a function F (x, y, z)=0, and every point not on the curved surface S does not accord with the function F (x, y, z)=0, the function F (x, y, z)=0 is regarded as the function of the curved surface. In addition, with the plurality of groups of coordinates (x, y, z), it can obtain the function F (x, y, z) which corresponds to the ball 50.

The curved surface creating module 270 creates a curved surface according to the function F (x, y, z)=0. The curved surface is regarded as a 3D model of the ball 50.

As follows, it is described in detail to show how to obtain the 3D model of the ball 50. Referring to FIG. 3, the two TOF cameras 10a and 10b are respectively on the right side and the left side of the ball 50. A radius of the ball 50 is R. Five points A, B, C, D, and E on the ball 50 are selected. A distance between the ball 50 and the TOF camera 10a, namely a distance between a centre of the ball 50 and the TOF camera 10a, is L.

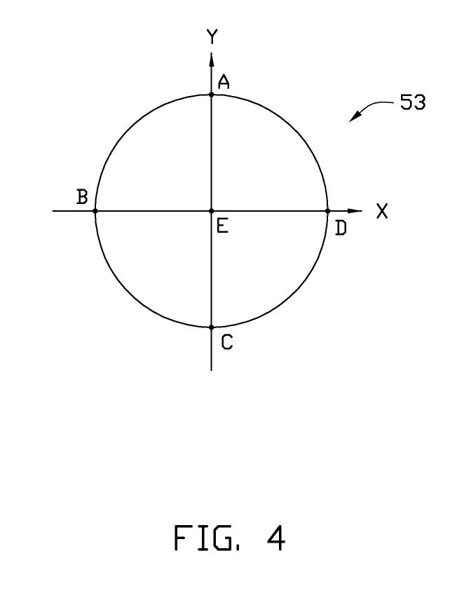

After the TOF cameras 10a and 10b turn on by the startup module 210, the TOF cameras 10a and 10b shoot the ball 50. An image 53 in FIG. 4 is obtained by the TOF camera 10a. An image obtained by the TOF camera 10b is similar with the image 53 except for the point E.

A center of the image 53 is regarded as an origin of the X-axis, the Y-axis, and the Z-axis. According to FIG. 4, with the first coordinate calculating module 220, the coordinates of the five points A, B, C, D, and E in the image 53 on the X-Y plane are (0, R), (−R, 0), (−R, 0), (R, 0), and (0, 0) respectively. In other embodiments, the first coordinate calculating module 220 can obtain the coordinates of more points in the image 53.

When the TOF camera 10a shoots the ball 50, the TOF camera 10a sends electrical signals to the ball 50 and the ball 50 reflects the electrical signal to the camera 10a. As a result, the distance data can be obtained according to time differences between sending and receiving the electrical signals of the TOF camera 10a. In FIG. 4, it can be known that a distance between each of the points A, B, C and D and the TOF camera 10a which is calculated (\sqrt{L²+R²}), and a distance between the point E and the TOF camera 10a which is calculated (L−R).

According to distances between the five points A, B, C, D and E, and the TOF camera 10a, the second coordinate calculating module 230 calculates coordinates of the five points A, B, C, D, and E on the Z-axis are (0), (0), (0), (0), and (R) respectively. In other embodiments, the second coordinate calculating module 230 may obtain coordinates of more points on the Z-axis.

The coordinate storing module 250 stores the coordinates of the five points A, B, C, D, and E from the first coordinate calculating module 220 and the second coordinate calculating module 230. As a result, five groups of coordinates (0, R, 0), (−R, 0, 0), (0, −R, 0), (R, 0, 0), and (0, 0, R) are stored in the coordinate storing module 250. In other embodiments, more than five groups of coordinates may be stored in the coordinate storing module 250.

The curved surface function calculating module 260 obtains a function F (x, y, z)=x²+y²+z²−R²=0 according to the five groups of coordinates stored in the coordinate storing module 250. It can be known that the curved surface function calculating module 260 uses well known technology to obtain the function F (x, y, x)=0 according to a plurality of groups of coordinates stored in the coordinate storing module 250. For example, Matlab software, can obtain the function F (x, y, x)=0 according to a plurality of groups of coordinates.

The curved surface creating module 270 creates a curved surface according to the function F (x, y, z)=x²+y²+z²−R²=0. The curved surface is regarded as the 3D model of the ball 50.

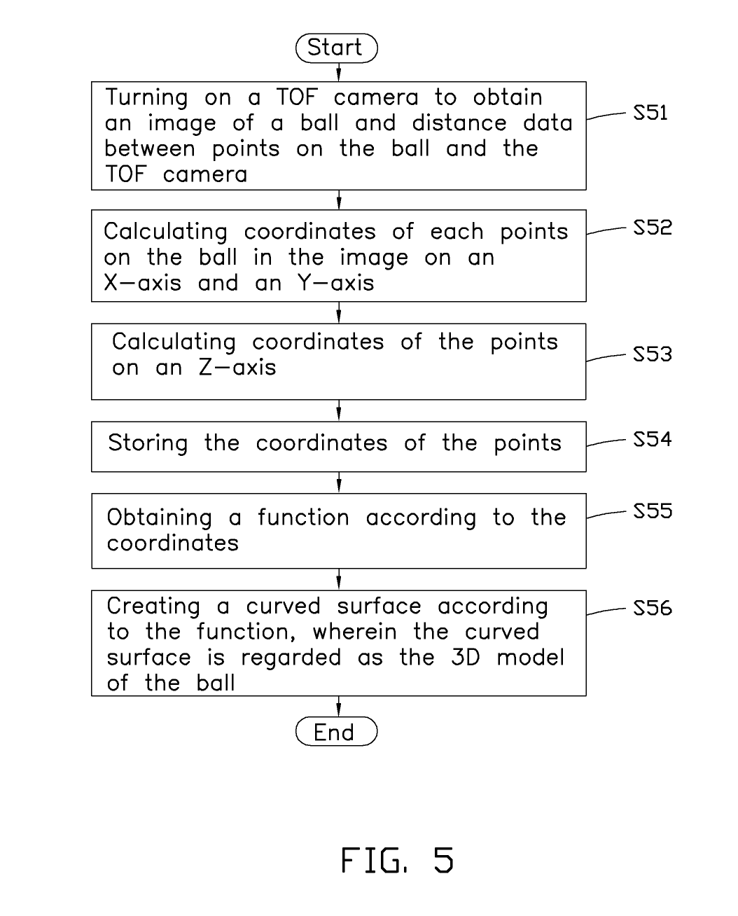

Referring to FIG. 5, an exemplary embodiment of a three dimension model building method includes the following steps.

In step S51, the startup module 210 turns on the TOF camera 10a. The TOF camera 10a shoots the ball 50 from different views to obtain the images of the ball 50. In addition, the TOF camera 10a obtains a distance between each of the four points A, B, C, and D on the ball 50 and the TOF camera 10a which is calculated (\sqrt{L²+R²}), and a distance between the point E on the ball 50 and the TOF camera 10a which is calculated (L−R).

In step S52, the first coordinate calculating module 220 calculates coordinates of the five points A, B, C, D, and E of the ball 50 in the image 53 from the TOF camera 10a on the X-Y plane. In the embodiment, a center of the image 53 of the ball 50 is regarded as an origin of the X-Y plane. As a result, the coordinates of the five points A, B, C, D, and E in the image 53 on the X-Y plane are (0, R), (−R, 0), (−R, 0), (R, 0), and (0, 0) respectively.

In step S53, according distances between the five points A, B, C, D and E, and the TOF camera 10a, the second coordinate calculating module 230 calculates coordinates of the five points A, B, C, D, and E on the Z-axis are (0), (0), (0), (0), and (R) respectively. In the embodiment, the center of the ball 50 is regarded as an origin of the Z-axis.

In step S54, the coordinate storing module 250 stores the coordinates of the five points A, B, C, D, and E from the first coordinate calculating module 220 and the second coordinate calculating module 230. As a result, five groups of coordinates (0, R, 0), (−R, 0, 0), (0, −R, 0), (R, 0, 0), and (0, 0, R) are stored in the coordinate storing module 250. In other embodiments, more than five groups of coordinates may be stored in the coordinate storing module 250.

In step S55, the curved surface function calculating module 260 obtains a function F (x, y, z)=x²+y²+z²−R²=0 according to the five groups of coordinates stored in the coordinate storing module 250.

In step S56, the curved surface creating module 270 creates a curved surface according to the function F (x, y, z)=x²+y²+z²−R²=0. The curved surface is regarded as the 3D model of the ball 50.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A three dimension model building system comprising:
a plurality of time-of-flight (TOF) cameras to capture images of an object and obtain distance data between each of selected points on the object and the TOF cameras;
a processing unit; and
a storage system connected to the processing unit and storing a plurality of modules to be executed by the processing unit, wherein the plurality of modules comprise:
a first coordinate calculating module to calculate coordinates of the points on the object in the images on an X-axis and an Y-axis;
a second coordinate calculating module to calculate coordinates of the points on the object in the images on an Z-axis according to the distance data;
a curved surface function calculating module to obtain a function according to the plurality groups of coordinates of the points on the X-axis, the Y-axis, and the Z-axis; and
a curved surface creating module to create a curved surface according to the function, wherein the curved surface is a three dimension model of the object.

2. The three dimension model building system of claim 1, further comprising a startup module to turn on the plurality of TOF cameras.

3. The three dimension model building system of claim 1, wherein the plurality of TOF cameras form a camera array located around the object.

4. The three dimension model building system of claim 1, further comprising a coordinate storing module to store the coordinates of the points on the object in the images.

5. A three dimension model building method comprising:
capturing images of an object and obtaining distance data between each of selected points on the object and a plurality of TOF cameras respectively;
calculating coordinates of the points on the object in the images on an X-axis and an Y-axis;
calculating coordinates of the points on the object in the images on an Z-axis according to the distance data between the points on the object and the TOF cameras;
obtaining a function according to the plurality of groups of coordinates of the points; and
creating a curved surface according to the function, wherein the curved surface is a three dimension model of the object.

6. The three dimension model building method of claim 5, wherein before the step of capturing an image of the object and distance data between points on the object:
turning on the plurality of TOF cameras.

7. The three dimension model building method of claim 5, wherein the plurality of TOF cameras form a camera array located around the object.
